(19) United States
(12) Patent Application Publication
(10) Pub. No.: US 2005/0134053 A1
(43) Pub. Date: Jun. 23, 2005

(54) Storage of actuation energy in automotive door latch

(75) Inventors: Nigel V. Spurr, Shirley (GB); Michael J. Shelley, Fauldhouse (GB); Richard T. Hayes, Motherwell (GB); William F. Eaton, Pearl City, IL (US); Hugh D. Gibson, Edinburgh (GB); Alex Crawford, East Kilbride (GB); Ajaykumar Vaidhyanathan, Chennai (IN); Scott A. Vorwald, Lena, IL (US); Kenneth V. Bechtold, Freeport, IL (US); Curtis B. Johnson, Freeport, IL (US); Duncan S. Murchie, Crieff (GB); Daniel D. Kilker, University Park, FL (US); Abanni B. Maxwell, Rockford, IL (US); Patrick H. Shannon, Eskbank (GB); Gillian J. Madden, Bothwell (GB); Adrian T. Kettle, Shrivenham (GB)

Correspondence Address: Attorney, Intellectual Property;Honeywell International, Inc., 101 Columbia Rd., P.O. Box 2245, Morristown, NJ, 07962, US

(73) Assignee: Honeywell International, Inc.

(21) Appl. No.: 10/745,388

(22) Filed: Dec. 23, 2003

(51) Int. Cl. E05C 3/06

(52) U.S. Cl. 292/201

(57) ABSTRACT

In general, a spring or spring mechanism can be associated with a latch mechanism wherein the spring is wound to a particular position thereof to store energy for dissipation and actuation of the latch mechanism. The latch mechanism is responsive to the spring, and can be actuated based on energy stored and dissipated from the spring. When required, spring energy can therefore be dissipated to actuated the latch or latch mechanism. Thus, a motor with low current consumption and suitable gearing can be utilized to apply a high force to the spring.

### TECHNICAL FIELD

Embodiments are generally related to door latch assemblies, including door latching mechanisms utilized in automobiles and other vehicles. Embodiments are also related to low current consumption motors and gear mechanisms utilized in door latch assemblies. Embodiments are additional related to methods and systems for actuating door latches.

### BACKGROUND OF THE INVENTION

Latching mechanisms are utilized in a variety of commercial and industrial applications, such as automobiles, airplanes, trucks, and the like. For example, an automotive closure, such as a door for an automobile passenger compartment, is typically hinged to swing between open and closed positions and conventionally includes a door latch that is housed between inner and outer panels of the door. The door latch functions in a well-known manner to latch the door when it is closed and to lock the door in the closed position or to unlock and unlatch the door so that the door can be opened manually.

The door latch can be operated remotely from inside the passenger compartment by two distinct operators—a sill button or electric switch that controls the locking function and a handle that controls the latching function. The door latch is also operated remotely from the exterior of the automobile by a handle or push button that controls the latching function. A second distinct exterior operator, such as a key lock cylinder, may also be provided to control the locking function, particularly in the case of a front vehicle door. Each operator is accessible outside the door structure and extends into the door structure where it is operatively connected to the door latch mechanism by a cable actuator assembly or linkage system located inside the door structure.

Vehicles, such as passenger cars, are therefore commonly equipped with individual door latch assemblies which secure respective passenger and driver side doors to the vehicle. Each door latch assembly is typically provided with manual release mechanisms or lever for unlatching the door latch from the inside and outside of the vehicle, e.g. respective inner and outer door handles. In addition, many vehicles also include an electrically controlled actuator for remotely locking and unlocking the door latches.

One of the problems inherent with conventional latching mechanisms is that it is difficult, but necessary, to actuate the latching mechanism in a manner that achieves low current consumption in association with a high actuation force and a short operating time. Conventional latching mechanisms are often subject to inefficiencies in this particular area. Therefore, an improved method and system is needed in which both a high actuation force and low current consumption can be achieved.

### BRIEF SUMMARY OF THE INVENTION

The following summary of the invention is provided to facilitate an understanding of some of the innovative features unique to the present invention and is not intended to be a full description. A full appreciation of the various aspects of the invention can be gained by taking the entire specification, claims, drawings, and abstract as a whole.

It is, therefore, one aspect of the present invention to provide for an improved latch mechanism.

It is another aspect of the present invention to provide for improved latching methods and systems for use in automobiles and other vehicles.

It is yet a further aspect of the present invention to provide for an improved door latch actuating method and system.

The aforementioned aspects of the invention and other objectives and advantages can now be achieved as described herein. A latch actuation method and system is disclosed herein. In general, a spring or spring mechanism can be associated with a latch mechanism wherein the spring is wound to a particular position thereof to store energy for dissipation and actuation of the latch mechanism. The latch mechanism is responsive to the spring, and can be actuated based on energy stored and dissipated from the spring. When required, spring energy can therefore be dissipated to actuated the latch or latch mechanism. Thus, a motor with low current consumption and suitable gearing can be utilized to apply a high force to the spring. When spring energy is released to actuate the latch, energy can be applied much more quickly than utilizing only conventional motors and gearing thereof. A low current consumption with a high force and short operating time can thus be implemented for door latch actuators, particularly actuators utilized in vehicle door latch assemblies and mechanisms thereof.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a perspective view of a vehicle door mounted to a passenger vehicle in which a preferred embodiment of the present invention can be implemented;

FIG. 2 illustrates a block diagram of a system, which can be implemented in accordance with a preferred embodiment of the present invention; and

FIG. 3 illustrates a block diagram of a system, which can be implemented in accordance with an alternative embodiment of the present invention.

### DETAILED DESCRIPTION OF THE INVENTION

The particular values and configurations discussed in these non-limiting examples can be varied and are cited merely to illustrate at least one embodiment of the present invention and are not intended to limit the scope of the invention.

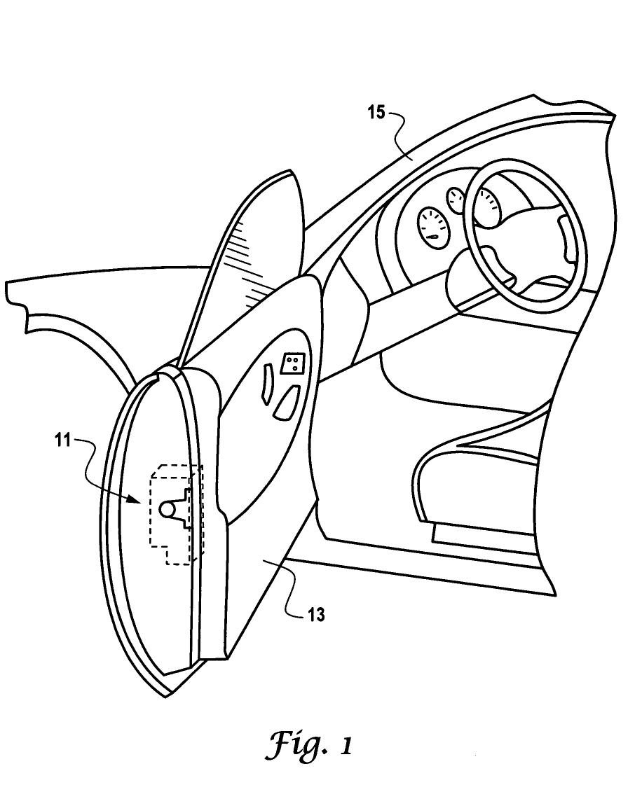

FIG. 1 illustrates a perspective view of a vehicle door 13 mounted to a passenger vehicle in which a preferred embodiment of the present invention can be implemented. A vehicle, such as an automobile can be equipped with one or more individual door latch assemblies 11, which secure respective passenger and driver side doors to the vehicle 15. Each door latch assembly 11 is typically provided with manual release mechanisms or lever for unlatching the door latch from the inside and outside of the vehicle, e.g. respective inner and outer door handles. In addition, many vehicles can also be equipped with electrically controlled actuators for remotely locking and unlocking the door latches. As indicated in FIG. 1, a door latch assembly 11 can be mounted to a driver's side vehicle door 13 of a passenger vehicle 15. The door latch assembly 11 may be mounted to front and rear passenger side doors thereof and may be incorporated into a sliding side door, rear door, a rear hatch or a lift gate thereof, depending upon design constraints.

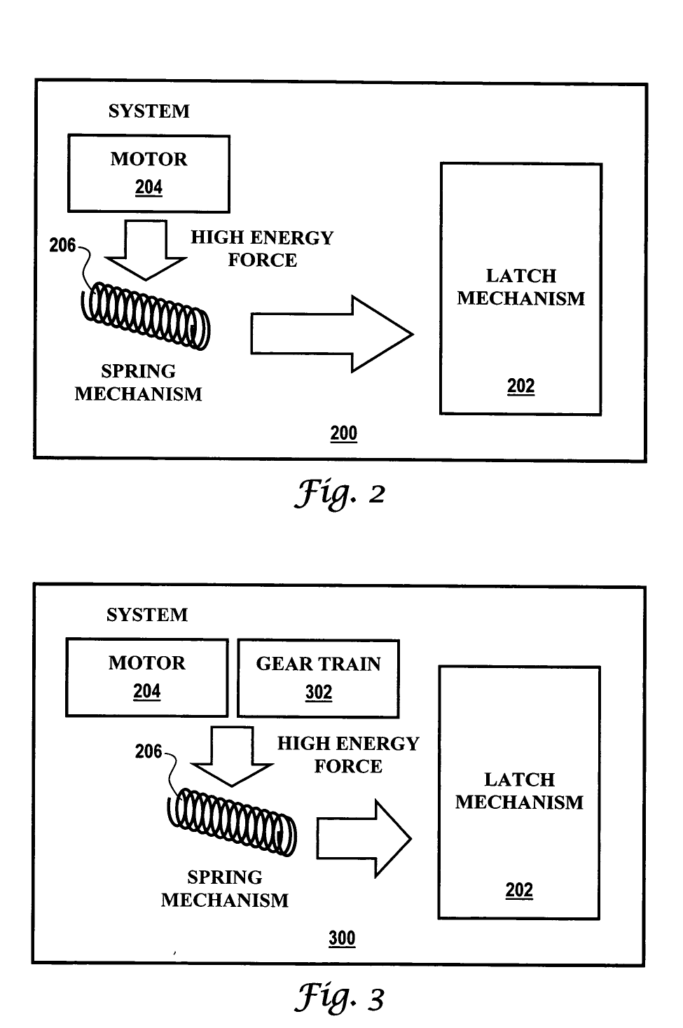

FIG. 2 illustrates a block diagram of a system 200, which can be implemented in accordance with a preferred embodiment of the present invention. In general, a spring or spring mechanism 206 can be associated with a latch mechanism 202 wherein the spring 206 is wound to a particular position thereof to store energy for dissipation and actuation of the latch mechanism 202. The latch mechanism 202 is responsive to the spring, and can be actuated based on energy stored and dissipated from the spring 206. When required, spring energy can therefore be dissipated to actuated the latch or latch mechanism 202.

System 200 also can include a motor 204 with low current consumption, which can be utilized to apply a high force to the spring. 206 When spring energy is released to actuate the latch 202, energy can be applied much more quickly than utilizing only conventional motors and gearing thereof. A low current consumption with a high force and short operating time can thus be implemented for door latch actuators, particular actuators utilized vehicle door latch assemblies and mechanisms thereof, such as, for example, vehicle door latch assembly 11 of FIG. 1.

FIG. 3 illustrates a block diagram of a system 300, which can be implemented in accordance with an alternative embodiment of the present invention. Note that in FIGS. 2 and 3, identical or similar parts or components are indicated by identical reference numerals. System 300 generally includes a spring 206 associated with a latch mechanism 202 wherein the spring 206 can be wound to a particular position thereof to store energy for dissipation and actuation of the latch mechanism 202.

Latch mechanism 202 is generally responsive to spring 206, wherein the latch mechanism 202 is actuated based on energy stored and dissipated from the spring 296. System 300 additionally includes a motor 204 for applying a high force to the spring to initiate a release of energy from the spring 206 for actuation of the latch mechanism 202. Motor 204 generally comprises a low current consumption motor. System 302 additionally includes a gear train 302 (i.e., a gear mechanism) responsive to the motor 204, wherein the motor 204 and the gear mechanism 302 together apply a high force to the spring 206 to permit the spring to release stored energy thereof for actuating the latch mechanism 202. In general, in systems 200 and 300, actuating speed is not governed by the motor and gearing. Thus, a motor with low current consumption, such as motor 204 and suitable gearing, such as gear train 302, may apply a high force to spring 206 for actuation of latch mechanism 202.

It can be appreciated that a variety of different types of latch assemblies can be implemented in accordance with varying embodiments of the present invention. One non-limiting example of a latch assembly that can be adapted for use with the present invention is shown in U.S. Pat. No. 6,511,107, “Electrically controlled actuator for a vehicle door latch assembly,” which issued to Barczynski et al on Jan. 28, 2003 and is incorporated herein by reference. It can be appreciated that U.S. Pat. No. 6,511,107 is referenced herein for general illustrative and edification purposes only and is not considered a limiting feature any embodiments of the present invention.

The embodiments and examples set forth herein are presented to best explain the present invention and its practical application and to thereby enable those skilled in the art to make and utilize the invention. Those skilled in the art, however, will recognize that the foregoing description and examples have been presented for the purpose of illustration and example only. Other variations and modifications of the present invention will be apparent to those of skill in the art, and it is the intent of the appended claims that such variations and modifications be covered.

The description as set forth is not intended to be exhaustive or to limit the scope of the invention. Many modifications and variations are possible in light of the above teaching without departing from the scope of the following claims. It is contemplated that the use of the present invention can involve components having different characteristics. It is intended that the scope of the present invention be defined by the claims appended hereto, giving full cognizance to equivalents in all respects.

1. A latch actuation system, comprising:
a spring associated with a latch mechanism wherein said spring is wound to a particular position thereof to store energy for dissipation and actuation of said latch mechanism;
a latch mechanism responsive to said spring, wherein said latch mechanism and said spring are integrated with a door latch assembly, wherein said latch mechanism is actuated based on energy stored and dissipated from said spring within said door latch assembly, and
a gear mechanism for applying a high force to said spring to initiate a release of energy from said spring actuation of said latch mechanism, wherein said gear mechanism comprises a gear train.

2. The system of claim 1 further comprising a motor for applying a high force to said spring to initiate a release of energy from said spring for actuation of said latch mechanism.

3. (canceled)

4. (canceled)

5. The system of claim 2 wherein said motor comprises a low current consumption motor.

6. The system of claim 1 further comprising a motor associated with a gear mechanism responsive to said motor, wherein said motor and said gear mechanism together apply a high force to said spring to permit said spring to release stored energy thereof for actuating said latch mechanism.

7. The system of claim 1 wherein said latch mechanism comprises a vehicle door latch of an automotive vehicle.

8. The system of claim 1 wherein said spring comprises a gear train spring.

9. A latch actuation system, comprising:
a spring associated with a latch mechanism wherein said spring is wound to a particular position thereof to store energy for dissipation and actuation of said latch mechanism;
a latch mechanism responsive to said spring, wherein said latch mechanism and said spring are integrated with a door latch assembly, wherein said latch mechanism is actuated based on energy stored and dissipated from said spring within said door latch assembly; and
a motor for applying a high force to said spring to initiate a release of energy from said spring for actuation of said latch mechanism.

10. The system of claim 9 wherein said motor comprises a low current consumption motor.

11. The system of claim 9 further comprising a gear mechanism responsive to said motor, wherein said motor and said gear mechanism together apply a high force to said spring to permit said spring to release stored energy thereof for actuating said latch mechanism.

12. The system of claim 9 wherein said latch mechanism comprises a vehicle door latch of an automotive vehicle.

13. The system of claim 1 wherein said spring comprises a gear train spring.

14. A latch actuation method, comprising the steps of:
associating a spring with a latch mechanism wherein said spring is wound to a particular position thereof to store energy for dissipation and actuation of said latch mechanism;
configuring said latch mechanism wherein said latch mechanism is responsive to said spring;
integrating said latch mechanism and said spring within a door latch assembly, wherein said latch mechanism is actuated based on energy stored and dissipated from said spring within said door latch assembly, and
providing a motor for applying a high force to said spring to initiate a release of energy from said spring for actuation of said latch mechanism.

15. The method of claim 14 further comprising the step of providing a motor for applying a high force to said spring to initiate a release of energy from said spring for actuation of said latch mechanism.

16. The method of claim 14 further comprising the step of providing a gear mechanism for applying a high force to said spring to initiate a release of energy from said spring for actuation of said latch mechanism.

17. The method of claim 15 wherein said gear mechanism comprises a gear train.

18. The method of claim 15 wherein said motor comprises a low current consumption motor.

19. The method of claim 14 further comprising the step of providing a motor associated with a gear mechanism responsive to said motor, wherein said motor and said gear mechanism together apply a high force to said spring to permit said spring to release stored energy thereof for actuating said latch mechanism.

20. The method of claim 14 wherein said latch mechanism comprises a vehicle door latch of an automotive vehicle.
